(19) United States
(12) Patent Application Publication
(10) Pub. No.: US 2008/0280551 A1
(43) Pub. Date: Nov. 13, 2008

(54) Garage and Outbuilding Safety Ventilation System

(75) Inventor: Nicholas Ashworth, Dublin, OH (US)

Correspondence Address: REINHART BOERNER VAN DEUREN P.C., 2215 PERRYGREEN WAY, ROCKFORD, IL, 61107, US

(73) Assignee: RANCO INCORPORATED OF DELAWARE, Wilmington, DE (US)

(21) Appl. No.: 11/746,101

(22) Filed: May 9, 2007

(51) Int. Cl. E06B 7/02; G08B 21/14

(52) U.S. Cl. 454/195

(57) ABSTRACT

A ventilating system for a garage is provided. The ventilating system comprises an automatic garage door opening mechanism and a hazardous gas detector. The automatic garage door opening mechanism is configured for wireless communication and to move a garage door between an open position and a closed position. The hazardous gas detector is configured for wireless communication and to sense the presence of a hazardous gas within the garage. The hazardous gas detector wirelessly instructs the automatic garage door opening mechanism to move the garage door to the open position when the hazardous gas reaches a predetermined level in the garage. As such, the garage is ventilated.

### FIELD OF THE INVENTION

This invention generally relates to a ventilation system and, in particular, to a ventilation system for a garage or outbuilding.

### BACKGROUND OF THE INVENTION

It is well known that combustion appliances (e.g., heaters) and internal combustion engines (e.g., in automobiles and other vehicles) generate carbon monoxide gas. Carbon monoxide gas is poisonous and, at high levels, can lead to serious injury and even death when inhaled by human beings and animals. Accumulation of carbon monoxide often occurs inside a home near combustion appliances and within a garage where vehicles are stored.

All too often, combustion appliances found in homes are not adequately ventilated. Likewise, a common practice is to start an automobile while in the garage and leave it running to warm up the automobile during the winter months. Unfortunately, often the owner only opens the garage door partially to let the fumes escape while avoiding too much snow from blowing into the garage. Other common practices are to grill in the garage during inclement weather or use a propane heater to heat the garage while working in it. As with warming up the car, often the owner opens the garage door only slightly so as to prevent the rain from blowing into the garage or to allow the garage to be heated to a comfortable temperature. As a result of these practices, carbon monoxide is able to accumulate to dangerous concentrations.

Several attempts have been made to sense and monitor the level of carbon monoxide in both the home and the garage using, for example, a carbon monoxide detector. If the level of carbon monoxide is dangerously high and/or at too large a concentration for too long a period of time, the conventional carbon monoxide detector generates an audible or visual warning signal. Unfortunately, these warning signals may go unnoticed if, for example, they are not seen and/or heard. As a result, the home or garage will not be properly ventilated and the concentration of the carbon monoxide may escalate.

Thus, it would be desirable and beneficial to have a hazardous gas detector that communicates wirelessly with a garage door opener to automatically ventilate a garage or other structure when a predetermined level of a hazardous gas is detected. The invention provides such a hazardous gas detector. These and other advantages of the invention, as well as additional inventive features, will be apparent from the description of the invention provided herein.

### BRIEF SUMMARY OF THE INVENTION

A hazardous gas detector that communicates wirelessly with a garage door opener to automatically ventilate a garage or other structure when a predetermined level of a hazardous gas is detected is provided. Because the detector and garage door opener communicate wirelessly, installation of the garage door opener is accomplished without the need for adding additional wiring, hiring an electrician, and a garage door opener that has extra or available inputs.

In one embodiment a hazardous gas detector for ventilating a structure is provided. The structure has a barrier opening mechanism configured to move a barrier into an open position. The hazardous gas detector includes a sensor for sensing a hazardous gas within the structure. The transmitter is operably coupled to the sensor and wirelessly instructs the barrier opening mechanism to move the barrier to the open position when the sensor senses a predetermined level of the hazardous gas within the structure. As such, the structure is ventilated.

In another embodiment, a ventilating system for a garage including an automatic garage door opening mechanism and a hazardous gas detector is provided. The automatic garage door opening mechanism is configured for wireless communication and to move a garage door between an open position and a closed position. The hazardous gas detector is configured for wireless communication and to sense the presence of a hazardous gas within the garage. In addition, the hazardous gas detector wirelessly instructs the automatic garage door opening mechanism to move the garage door to the open position when the hazardous gas reaches a predetermined level in the garage. As such, the garage is ventilated.

In yet another embodiment, a ventilating system for a garage is provided. The ventilating system includes an automatic garage door opening mechanism, a door position sensing device, and a carbon monoxide detector. The automatic garage door opening mechanism is configured for wireless communication and to move a garage door between an open position and a closed position. The door position sensing device is configured to sense the position of the garage door at and between the open and closed positions. The carbon monoxide detector is configured for wireless communication and to sense the presence of carbon monoxide within the garage. The carbon monoxide detector wirelessly communicates with the automatic garage door opening mechanism when the carbon monoxide reaches a predetermined level in the structure. As such, the automatic garage door opening mechanism moves the garage door from the closed position to the open position to ventilate the garage.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a carbon monoxide detector, disposed within a garage, constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

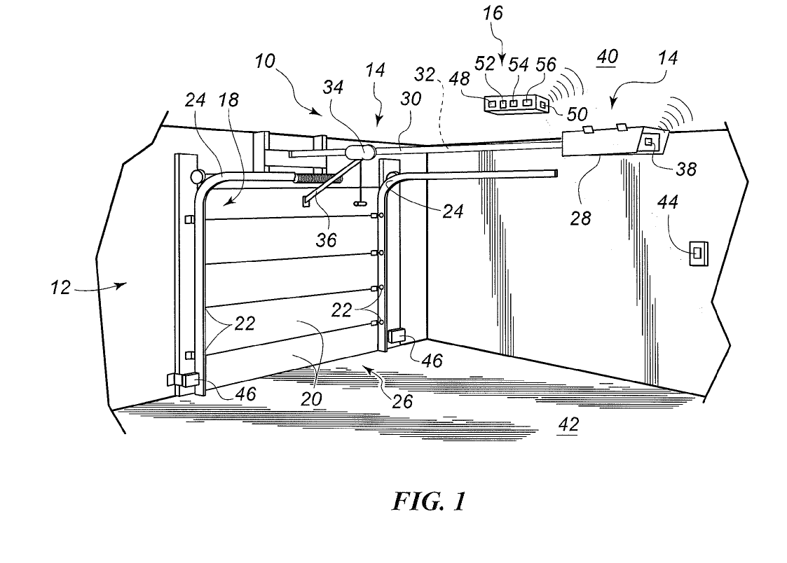

Referring to FIG. 1, a ventilating system 10 is illustrated. The ventilating system 10 is preferably employed within a confined area such as, for example, a garage 12, an outbuilding, a room in a residential dwelling, and the like. As shown in FIG. 1, the ventilating system 10 comprises a barrier opening mechanism 14 and a hazardous gas detector 16.

In general, the barrier opening mechanism 14 is an apparatus, device, and/or assembly configured to move a barrier 18 such as, for example, a garage door, a window, a vent, an access flap, and combinations thereof. In the embodiment of FIG. 1, the barrier opening mechanism 14 and the barrier 18 are shown, for the purpose of illustration and to aid in describing the invention, as an automatic garage door opener and a garage door, respectfully. Even so, one skilled in the art will appreciate that the invention may be used with various other barrier opening mechanisms and barriers without departing from the scope of the invention.

As illustrated in FIG. 1, the garage door 18 has a plurality of interconnected door panels 20 or segments. Each door panel 20 has one or more pairs of vertically spaced rollers 22 that are guided by and in a generally parallel pair of tracks 24. The tracks 24 are mounted adjacent an opening 26 which, in FIG. 1, is blocked by the garage door 18. The tracks 24 guide the garage door 18 between a closed position (FIG. 1) and an open position where a vehicle can enter and exit the garage 12.

As shown in FIG. 1, the barrier opening mechanism 14 comprises a reversible electric motor 28, a rail 30, a biasing member 32, a trolley 34, a bracket 36, and a wireless communication device 38. The reversible electric motor 28 is suspended below a ceiling 40 of the garage 12 and is generally positioned at one end of the rail 30. The reversible electric motor 28 is operably coupled to the biasing member 32 which is, for example, an elongated screw, a chain, a gear, and the like. The biasing member 32 is typically supported by, and often hidden within, the rail 30. The reversible electric motor 28 is configured, when actuated, to act upon and/or move the biasing member 32.

The trolley 34 or follower is configured to be variably positioned along a length of the rail 30 and, in FIG. 1, is shown in spaced relation to the reversible electric motor 28. The trolley 34 is generally equipped to smoothly ride and/or move along the length of the rail 30. Also, the trolley 34 is operably coupled to the biasing member 32 such that any movement of the biasing member 32 is translated to the trolley. Therefore, the distance between the trolley 34 and the reversible electric motor 28 can be reduced or enlarged when the reversible electric motor is switched on.

The bracket 36 is securely attached to each of the trolley 34 and one or more of the door panels 20 forming the garage door 18. Therefore, any movement by the trolley 34 is experienced by the garage door 18. While the trolley 34 travels in a generally horizontal direction along the length of the rail 30, the segmented garage door panels 20 permit the garage door 18 to first move vertically upwardly and then horizontally back toward the reversible electric motor 28 as the rollers 22 guide the garage door along the tracks 24.

When the reversible electric motor 28 is activated and the garage door 18 is in the closed position (FIG. 1), the biasing member 32 draws the trolley 34 along the rail 30 toward the reversible electric motor. Resultantly, the trolley 34 pulls at the bracket 36 and the bracket lifts the garage door 18 upwardly and then back along the tracks 24. Eventually, the trolley 34 tows the garage door 18 along the tracks 24 until the door panels 20 of the garage door 18 are translated from a vertical orientation, where they block the opening 26, to a horizontal orientation where they expose the opening. When the opening 26 is exposed, the door panels 20 of the garage door 18 are generally suspended upon or by the tracks 24 just below, and generally parallel with, the ceiling 40 of the garage 12.

When the reversible electric motor 28 is activated and the garage door 18 is in the open position, the biasing member 32 moves the trolley 34 away from the reversible electric motor. Resultantly, the trolley 34 pushes the bracket 36 and the bracket lowers the garage door 18 toward the floor 42. Eventually, the trolley 34 biases the garage door 18 along the tracks 24 until the door panels 20 are translated from the horizontal orientation to the vertical orientation where they once again fill the opening 26 as shown in FIG. 1.

In addition to being able to move the garage door 18 between the open and closed positions, the opening mechanism 14 is able to communicate wirelessly using the wireless communication device 38. The wireless communication device 38 is a transmitter, a receiver, or both. In one embodiment, the wireless communication device 38 is at least one of a radio frequency transmitter and a radio frequency receiver. In such an embodiment, the transmitter and receiver operate in a frequency range of about three hundred to about four hundred megahertz.

Since the opening mechanism 14 is configured for wireless communication, a wall switch 44 outfitted with a cooperating transmitter and/or receiver can be used to actuate the reversible electric motor 28. When the wall switch 44 is depressed or otherwise manipulated, the electric motor 28 of the opening mechanism 14 is wirelessly activated and, as discussed above, alternatively opens and closes the garage door 18. The wall switch 44 can be located within the garage 12 or, in one embodiment, outside the garage in the form of an access pad, keyless entry system, and the like. In another embodiment, the wall switch 44 can be hard wired to the reversible electric motor 28.

In addition to being activated with the wall switch 44, the reversible electric motor 28 can be triggered using a remote control transmitter (not shown). As well known by users of conventional garage door openers and those skilled in the art, the remote control transmitter is typically carried in the vehicle (and secured to a visor) to actuate the reversible electric motor 28 and open the garage door 18 from outside the garage 12. Conveniently, the remote control transmitter permits the operator of the vehicle to open or close the garage door 18 without leaving the vehicle. This can be particularly beneficial in inclement weather.

In one embodiment, a pair of photo-eye sensors 46 are located adjacent the lower ends of the tracks 24. The photo-eye sensors 46 are configured and appropriately mounted to project a beam of light across the garage door opening 26. The beam of light will, when interrupted by an object such the garage door 18 during closing, reverse the movement of the garage door toward the open position. As such, the vehicle or person will not be inadvertently struck by or trapped underneath the descending garage door 18.

Still referring to FIG. 1, the hazardous gas detector 16 is shown generally disposed within the garage 12. The hazardous gas detector 16 comprises a sensor 48 and a wireless communication device 50. The sensor 48 is able to sense a harmful, potentially harmful, toxic, noxious, poisonous, and/or explosive gas (referred to collectively as a “hazardous” gas). Examples of such hazardous gases include, but are not limited to, carbon monoxide, radon, carbon dioxide, smoke, natural gas, propane, fuel vapors, solvent vapors, and the like.

In a preferred embodiment, the sensor 48 is able sense a presence and a predetermined level and/or concentration of the hazardous gas. In one embodiment, the hazardous gas detector 16 is a carbon monoxide detector and, correspondingly, the sensor 48 is a carbon monoxide sensor. In such an embodiment, the predetermined level of carbon monoxide is about one hundred parts per million over ninety minutes, about two hundred parts per million over thirty-five minutes, and about four hundred parts per million over fifteen minutes. In another embodiment, the predetermined level is between about fifty parts per million and about five hundred parts per million. As those skilled in the art will recognize and appreciate, a multitude of different sensors can be employed to sense a variety of different hazardous gases. Likewise, the sensitivity of these sensors can be set as desired to ensure safety.

The wireless communication device 50 employed by the hazardous gas detector 16 can be a transmitter, a receiver, or both. In one embodiment, the wireless communication device 50 is at least one of a radio frequency transmitter and a radio frequency receiver. In such an embodiment, the transmitter and receiver operate in a frequency range of about three hundred to about four hundred megahertz.

In one embodiment, the wireless communication device 50 of the hazardous gas detector 16 is programmable to adopt the communication protocol of the barrier opening mechanism 14. In other words, the wireless communication device 50 can be adapted to learn and speak the “language” of the barrier opening mechanism. In another embodiment, the barrier opening mechanism 14 is configured to adopt the communication protocol of the wireless communication device 50 of the hazardous gas detector 16 and/or other hazardous condition detectors located in and around a structure (e.g., home, office, etc.) attached to or proximate the garage 12 depicted in FIG. 1.

Because the wireless communication device 50 of the hazardous condition detector 16 is able to wirelessly communicate with the barrier opening mechanism 14, installation of the hazardous condition detector is relatively simple compared to applications where the detector and barrier opening mechanism communicate through a wired connection. Therefore, installation of the hazardous condition detector 16 in the garage 12 is accomplished without the need for installing cumbersome wiring, without the need to hire an electrician, and the like. In addition, wireless communication between the two devices permits the hazardous condition detector 16 and the barrier opening mechanism 14 to communicate despite a potential lack of additional or extra inputs, wiring ports, and the like, on the barrier opening mechanism which could receive a wire or operable coupling from the hazardous condition detector.

The hazardous condition detector 16 is, in one embodiment, interconnected via wireless communication with the other hazardous condition detectors located in and around the structure. An example of wirelessly interconnected hazardous condition detectors is found in U.S. patent application Ser. No. 10/966,832 entitled “Method for Initiating a Remote Hazardous Condition Detector Self Test and for Testing the Interconnection of Remote Hazardous Condition Detectors,” which is incorporated herein in its entirety.

The wireless communication device 50 of the hazardous gas detector 16 may also be programmable to adopt encryption and/or security features used by the barrier opening mechanism 14. For example, as well known to those skilled in the art, the barrier opening mechanisms 14 and remote control transmitters rely on a pseudo-random number generator to produce a rolling or hopping code for security purposes. In those instances, the wireless communication device 50 of the hazardous gas detector 16 is programmed or otherwise trained to communicate with the barrier opening mechanism 14. As such, the devices can cooperatively communicate with each other and can talk back and forth. In the illustrated embodiment, the hazardous gas detector 16 can include a memory device 52 to store one or more of security codes used by the barrier opening mechanism 14 as well as other information and data.

If desired, the barrier opening mechanism 14 may also be programmable to adopt encryption and/or security features used by the wireless communication device 50 of the hazardous gas detector 16 or the other hazardous condition detectors.

While the hazardous gas detector 16 is shown secured to the ceiling 40 of the garage 12 in FIG. 1, the hazardous gas detector can be positioned in other locations within the garage. In one embodiment, the hazardous gas detector 16 is situated proximate a portion of the garage door 18, the tracks 24, and the like and includes a position sensor 54 such as, for example, a magnetic switch. In such an embodiment, the position sensor 54 is able to sense the position of the garage door 18 and report that position back to the barrier opening mechanism 14.

In the illustrated embodiment, the hazardous gas detector 16 further includes a lock out system 56. The lock out system 56 at least temporarily prevents the garage door 18 from being remotely placed in the closed position after the predetermined level of hazardous gas has been reached and the garage door moved into the open position. In one embodiment, the garage door 18 must be manually closed after the predetermined level of hazardous gas has been sensed and the garage door resultantly opened.

In operation, when the sensor 48 in the hazardous condition detector 16 senses the presence or a predetermined level of the hazardous gas within the garage 12, the wireless communication devices 38, 50 communicate wirelessly. Through that wireless communication, the hazardous condition detector 16 instructs the barrier opening mechanism 14 to open the garage door 18. As the garage door 18 is moved into the open position from the closed position, fresh air from outside the garage 12 is permitted to enter the garage. Therefore, the concentration of the hazardous gas within the garage 12 is permitted to dissipate to a safe level or concentration and the garage is adequately ventilated.

While FIG. 1 illustrates the invention situated and employed within a garage 12, the invention can be used in a variety of different structures and/or locations such as, for example, in a bedroom with a vent, in a basement with an access flap, in an outbuilding with a fan, in a kitchen having a window and where a combustion appliance is being operated, a parking structure with a ventilation system, and the like, to name a few.

From the foregoing, those skilled in the art will recognize and appreciate that having a ventilation system 10 that can automatically ventilate an enclosed and/or partially enclosed structure when a predetermined level of a hazardous gas is detected is beneficial and desirable.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hazardous gas detector for ventilating a structure, the structure having a barrier opening mechanism configured to move a barrier into an open position, the hazardous gas detector comprising:
a sensor for sensing a hazardous gas within the structure; and
a transmitter operably coupled to the sensor, the transmitter wirelessly instructing the barrier opening mechanism to move the barrier to the open position when the sensor senses a predetermined level of the hazardous gas within the structure such that the structure is ventilated.

2. The hazardous gas detector of claim 1, wherein the hazardous gas is carbon monoxide.

3. The hazardous gas detector of claim 1, wherein the hazardous gas is carbon monoxide and the predetermined level is about one hundred parts per million over ninety minutes, about two hundred parts per million over thirty-five minutes, and about four hundred parts per million over fifteen minutes.

4. The hazardous gas detector of claim 1, wherein the transmitter adopts the transmission protocol of the barrier opening mechanism.

5. The hazardous gas detector of claim 1, wherein the open position permits air from outside the structure to enter the structure.

6. The hazardous gas detector of claim 1, wherein the transmitter is a radio frequency transmitter.

7. The hazardous gas detector of claim 1, wherein the transmitter requires the barrier opening mechanism to adopt the transmission protocol of the transmitter.

8. The hazardous gas detector of claim 1, wherein the transmitter uses one of a rolling code and a hopping code to wirelessly instruct the automatic barrier opening mechanism.

9. The hazardous gas detector of claim 1, wherein the transmitter is programmable to adopt a security code used by the barrier operating mechanism.

10. The hazardous gas detector of claim 9, wherein the hazardous gas detector comprises a memory for storing one or more of the security codes used by the barrier operating mechanism.

11. A ventilating system for a garage comprising:
an automatic garage door opening mechanism configured for wireless communication and to move a garage door between an open position and a closed position; and
a hazardous gas detector configured for wireless communication and to sense the presence of a hazardous gas within the garage, the hazardous gas detector wirelessly instructing the automatic garage door opening mechanism to move the garage door to the open position when the hazardous gas reaches a predetermined level in the garage such that the garage is ventilated.

12. The ventilating system of claim 11, wherein the automatic garage door opening mechanism includes a radio frequency receiver and the hazardous gas detector includes a radio frequency transmitter to establish the wireless communication.

13. The ventilating system of claim 11, wherein each of the automatic garage door opening mechanism and the hazardous gas detector includes a radio frequency receiver and a radio frequency transmitter to establish the wireless communication.

14. The ventilating system of claim 12, wherein the transmitter and receiver cooperatively use a pseudo-random number generator to secure the wireless communication.

15. The ventilating system of claim 11, wherein the hazardous gas detector is programmable to wirelessly communicate with the automatic garage door opening mechanism.

16. The ventilating system of claim 11, wherein the wireless communication between the automatic garage door opening mechanism and the hazardous gas detector occurs at a frequency of about three hundred to about four hundred megahertz.

17. The ventilating system of claim 11, wherein the automatic garage door opening mechanism includes a lock out system, the lock out system at least temporarily preventing the garage door from being remotely placed in the closed position after the predetermined level has been reached and the garage door moved into the open position.

18. The ventilating system of claim 11, wherein the hazardous gas is carbon monoxide and the predetermined level is between about fifty parts per million and about five hundred parts per million.

19. A ventilating system for a garage comprising:
an automatic garage door opening mechanism configured for wireless communication and configured to move a garage door between an open position and a closed position;
a door position sensing device configured to sense the position of the garage door at and between the open and closed positions; and
a carbon monoxide detector configured for wireless communication and to sense the presence of carbon monoxide within the garage, the carbon monoxide detector wirelessly communicating with the automatic garage door opening mechanism when the carbon monoxide reaches a predetermined level in the structure such that the automatic garage door opening mechanism moves the garage door from the closed position to the open position to ventilate the garage.

20. The ventilating system of claim 19, wherein the door position sensing device is a magnetic switch.
